(19) United States
(12) Patent Application Publication
(10) Pub. No.: US 2014/0280418 A1
(43) Pub. Date: Sep. 18, 2014

(54) Numerical Method: Making the Infinite, Finite. A Universal Transform and System of Force Vector

(71) Applicant: Leonard Alan Bollingham, Baton Rouge, LA (US)

(72) Inventor: Leonard Alan Bollingham, Baton Rouge, LA (US)

(73) Assignee: Leonard Alan Bollingham, Baton Rouge, LA (US)

(21) Appl. No.: 13/802,161

(22) Filed: Mar. 13, 2013

(51) Int. Cl. G06F 17/10

(52) U.S. Cl. CPC G06F 17/10
USPC 708/400

(57) ABSTRACT

This innovation involves a proof of a necessary change in the universal transform describing natural laws. Instead of the prohibitively refining force velocity squared, this system is created by transforms which use force vectors: TWO distinct, separate force vectors that can work in different directions and create a perfect resultant force which will prevent so many of the anomalous problems across scientific design. As well as pave the way for great advancements and new levels of exactness.

### BACKGROUND

I offer a solution to unifying weak and strong EM forces with Gravity, Heat, and all other forces even emotion and religion with one consistent transform, and system of equations. A system of usage for these forces which is cleaner and less noisy, more efficient, and wholly directional. I start with a numerical method toolbox of infinite constructs, like Turing Abstract Computational Machines, Gaussian distributions or “Bell Curves”, abstract equations using God & Emotion, anomalies such as irregularities or anomalies across the designs of science, and the frame of reference where the information contained in the expansion/contraction cycle of a big bang event is infinite but countable. As only until the infinite is captured in some finite construct can studies be conducted accurately and completely.

These constructs, along with some anomalies, are used to create this system of equations and solve the problem of forcing Newton's gravity to adhere to system rules. In fact, all of the equations ended up being altered so that a single cohesive system of equations using an identical transform could be attained. This single cohesive transform is believed by all to be the method of checking correctness.

This patent is to claim the work that led to the refinement of the forces in transforms like P=R×I² to a directional vectorized system P=R×I₁×I₂. This work is the result of a dissertation that was never published or achieved. It is a fundamental shift to Fourier's Heat Transfer, Enstein's Energy, this example Ohm' Power, Newton's gravity can then be directed into this form, along with several other equations of natural laws. The resulting system can be used in conjuction with the “Bollingham Technique” cited in the patent application for Numerical Methods to Solve motion anomalies, to create a system wide universal transform and usable series of controllable vectorized forces. This system is the foundation for other devices and constructs that are not mentioned at this time.

### BRIEF SUMMARY OF THE INVENTION

By design this description tries to remain intuitive, and is not a mathematical treatise. In fact, the solution of a Grand and even Total Unification as described by Albert Einstein which is forwarded in this dissertation is heuristic in nature. There is minimal math involved. The introduction of this abstract sampling machine is to render finite the infinite. In other words, “An infinite machine, finished with an infinite problem, allows one to consider the task finite or computable. Then to move to a system of equations, using the rules of the system to force adherence, which allows for possible system wide refinements, and several avenues for future discovery.

To clarify about Turing and Church, one book I found on Theory of Computing was perfectly intuitive, but I am adding some more rigorous refinements to language here. “The assumption that the intuitive notion of ‘computable function’ can be identified with the class of partial recursive functions is known as Church's hypothesis or the Church-Turing thesis or sometimes Church's thesis.”¹

The investigator should not worry about the lack of complexity at this juncture. The power of this innovation is it's simplicity. Three degrees: BS in Petroleum Engineering, MS in Systems/Computer Science, an MBA, and tremendous work during the PhD quest are summarized in this innovation along with a lot of outside work. Instead of identifying just the major energies, this paper assumes all “energy events” are significant. In essence, all events of all kind, known or unknown must be represented to ensure “Total Unification”. This theoretical paper defines a method to build, classify, contain, and manage this “Total Unification”. Using the Normal Distribution, the Information Systems and Decision Sciences construct known as a “Bucket”, and a system transform pattern by Ohm, and Einstein. It was decided that to explain the anomalies across science such as circuits burning up for no reason, and the terminal velocity of skydiving to mention a few, that these equations needed a tweaking or adjustment, a relaxation or refinement to increase their accuracy and at the same time allow for anomalous adjustments in individual situations. Using this transform I have been investigating the use to create a working system of directional forces, with special emphasis on gravitational force vectors. The necessity arises from problems with overheating even with proper cooling, and other anomalies documented but unexplainable.

### BRIEF DESCRIPTION OF THE DRAWINGS

FIG. 1. FIG. 1 shows that all forces stronger than an Ohm, and smaller than an atomic explosion can be collected and arranged or ranked by energy and stacked by count if necessary, under the infinite construct of a Gaussian bell curve.

### DETAILED DESCRIPTION AND BEST MODE OF IMPLEMENTATION

Given all forces under the curve that are statistically significant and ignoring those outside the 3 Sigma limits of P, and E, we can solve the system of equations as a new development at this time. A foundation of all forces that can be quickly described as the resultant vector of a body or resistance, and a pair of force vectors acting nearly equally in force but varying in direction. This seems to be a subtle shift from the current form found in Ohm's Power, and Einstein's Energy, but it is an incredibly accurate improvement which involves a super set of possibilities not explained by the current form. Several problems of overheating, failure, and other strange occurrences are better explained by this new system of laws.

The current form is a very limited special circumstance where the force vectors are both the same size and act in the same exact direction. Under those circumstances the forces can be squared. By only offering this option all forces and relations are forced to act identically. This causes a serious imposition upon the resultant which can be measured as the difference between the actual resultant force and direction, and the adopted force and direction.

By relaxing this relationship between the two forces and the resultant force it is expected that savings and efficiencies of energy and heat can be realized. Only when all forces are accounted for with the infinite constructs could this change in the individual force vectors and the entire system be possible.

Four of the transforms are mentioned to illustrate this system, which allows us to fit or derive other natural laws into this form.

Power=Resistance×Icurrent₁×Icurrent₂

Energy=Mass×Cvelocity₁×Cvelocity₂

Gravity=Mass×Velocity₁×Velocity₂

God=Love×Anger₁×Anger₂

The last transform describing religious beliefs and emotions as God is love but at times a bit angry. Thus the angers are negative and multiplied to become positive. This is a fun equation that completed my sixth grade science project and finished the system. This allowed the study of this system to continue on a fun less rigorous level until the anamolous, mathematical, and philosophical exactness could be applied to fit Newton's Gravity to the other equations. Ohm's Power was rearranged with the use of the commutative law of multiplication to match the very popular from of Einstein's Energy. These three equations were used to try and fit Newton's gravity to this form. It was impossible, so when the work was finally completed all of the equations had to change some. A new transform is forwarded which can be used as a Natural law which will help in so many areas of work. The transforms can be combined in different systems of equations to address various problems. The Bell Curve of energy is a completed construct that makes all things mathematically and statistically significant, represented in a finite format. These two systems can then become a foundation for tremendous advancement. In summary the generic new transform would follow:

Fᵣₑₛᵤₗₜₐₙₜ=Mass/Resistance×Force−VelocityVector₁×Force−VelocityVector₂

From:

Force=Mass,Resistance×Force²

On the strength of these perfect similarities, it is also possible to apply for the designation of natural laws based on the designation of Ohm's Law. It is also important to note that the special case of having both Force-velocity Vectors equal in magnitude and direction results in the exact result of the current law where the velocity is squared.

I claim:

1. A numerical method system of infinite constructs which allow infinite problems, problems of massive complexity and nearly infinite rates of growth, uncomputable problems, etc., to be solved and made use of in finite ways.

2. The system in claim 1, where an adjustment to the transform made famous by Ohm's Power, and Einstein's Energy:
Force=Mass,Resistance×Force²
is changed to the transform:
Fᵣₑₛᵤₗₜₐₙₜ=Mass,Resistance×ForceVector₁×ForceVector₂.

3. The adjustment in claim 2, where the individual natural laws can be combined into systems of natural laws for various functions and problem solutions:
Power=R×I₁×I₂
Energy=M×C₁×C₂
Gravity=M×V₁×V₂
